(19) United States
(12) Patent Application Publication
(10) Pub. No.: US 2013/0265631 A1
(43) Pub. Date: Oct. 10, 2013

(54) FLEXIBLE DISPLAY APPARATUS

(71) Applicants: Yi-Joon Ahn, Yongin-si (KR); Jae-Ik Lim, Yongin-si (KR); Man-Seob Choi, Yongin-si (KR); Gee-Bum Kim, Yongin-si (KR); Yong-Seok Yeo, Yongin-si (KR)

(72) Inventors: Yi-Joon Ahn, Yongin-si (KR); Jae-Ik Lim, Yongin-si (KR); Man-Seob Choi, Yongin-si (KR); Gee-Bum Kim, Yongin-si (KR); Yong-Seok Yeo, Yongin-si (KR)

(21) Appl. No.: 13/602,010

(22) Filed: Aug. 31, 2012

(30) Foreign Application Priority Data
Apr. 6, 2012 (KR) 10-2012-0036260

(51) Int. Cl. G02F 1/01

(52) U.S. Cl. 359/295; 359/291

(57) ABSTRACT

A flexible display apparatus that has improved portability and convenience of usage. The flexible display apparatus includes a display main body that is flexible; and a bendable driving film coupled to the display main body, and that bends when an electric current flows. The flexible display apparatus may be flexibly transformed to be stored when it is carried, and then, may be unfolded to be flat through a simple manipulation when it is in use for displaying an image. Thus, the convenience of carrying and using the flexible display apparatus may be increased.

### CROSS-REFERENCE TO RELATED PATENT APPLICATION

This application claims priority to and the benefit of Korean Patent Application No. 10-2012-0036260, filed on Apr. 6, 2012, in the Korean Intellectual Property Office, the disclosure of which is incorporated herein in its entirety by reference.

### BACKGROUND

1. Field

The following description relates to a flexible display apparatus, and more particularly, to a flexible display apparatus for improving convenience of portability and usage.

2. Description of the Related Art

In general, flexible display apparatuses improve their flexibility by forming a display unit on a flexible substrate such as polyimide, and have an advantage of reduced volume by changing a shape thereof when the apparatuses are carried.

However, such an advantage when carrying the flexible display apparatuses may become a disadvantage when using the flexible display apparatuses. That is, the apparatuses have to be in a flat status when being used; however, a screen may be easily bent due to their flexible characteristic, and it may be difficult to see the screen without distortion.

To address this problem, a method of using a flexible display apparatus that fixes edges of the flexible display apparatus to a set or predetermined frame has been suggested recently; however, in this case, a thickness and a weight of the flexible display apparatus increase due to the additional frame.

Therefore, a flexible display apparatus having a new structure which is capable of improving convenience of portability and of usage without increasing a thickness and a weight thereof is necessary.

### SUMMARY

An aspect of an embodiment of the present invention is directed toward a flexible display apparatus having an improved structure that enables a user to see images without distortion by changing a shape of a main body when it is not in use and unfolding the main body when it is in use.

According to an embodiment of the present invention, there is provided a flexible display apparatus including: a display main body that is flexible; and a bendable driving film coupled to the display main body, and that bends when an electric current flows.

The bendable driving film may include a first electrode and a second electrode facing each other, and an electroactive medium disposed between the first and second electrodes, wherein components of the electroactive medium may concentrate to one of the first and second electrodes to induce a bending operation according to a direction of the electric current flowing in the first and second electrodes.

The electroactive medium may include one selected from the group consisting of ionic electroactive polymers, dielectric actuators, relaxor ferroelectric polymers, liquid crystal rubbers, and combinations thereof.

The ionic electroactive polymer may include one selected from the group consisting of ionic polymer metal composites, carbon nano tubes, conductive polymers, and combinations thereof.

The bendable driving film may be attached to a surface of the display main body as a single body.

The bendable driving film may be attached to a surface of the display main body as a plurality of divided pieces.

The bendable driving film may include a first bendable driving film and a second bendable driving film that are attached to the surface of the display main body along a first direction in parallel with each other.

The bendable driving film may include a first bendable driving film and a second bendable driving film attached to the surface of the display main body to cross each other.

A plurality of the bendable driving films may be attached to the surface of the display main body along a first direction in parallel with each other.

The bendable driving film may include upper film portions attached to an upper portion of a surface of the display main body along a first direction in parallel with each other, and lower film portions attached to a lower portion of the surface of the display main body in parallel with each other, and electric currents may respectively flow in the upper and lower film portions independent from each other.

The bendable driving film may include upper film portions attached to an upper portion of a surface of the display main body along a first direction in parallel with each other, lower film portions attached to a lower portion of the surface of the display main body in parallel with each other, and vertical film portions attached along a second direction that is perpendicular to the first direction, and electric currents may respectively flow in the upper film portion, the lower film portions, and the vertical film portions independent from each other.

### BRIEF DESCRIPTION OF THE DRAWINGS

The above and other features and advantages of the present invention will become more apparent by describing in detail exemplary embodiments thereof with reference to the attached drawings in which:

FIG. 1A is a perspective view of a flexible display apparatus according to an embodiment of the present invention;

FIG. 1B is a perspective view showing a bending state of the flexible display apparatus of FIG. 1A;

FIG. 2A is a perspective view of a flexible display apparatus according to another embodiment of the present invention;

FIG. 2B is a perspective view showing a bending state of the flexible display apparatus of FIG. 2A;

FIG. 3A is a perspective view of a flexible display apparatus according to another embodiment of the present invention;

FIG. 3B is a perspective view showing a bending state of the flexible display apparatus of FIG. 3A;

FIG. 4A is a perspective view of a flexible display apparatus according to another embodiment of the present invention;

FIG. 4B is a perspective view showing a bending state of the flexible display apparatus of FIG. 4A;

FIG. 5A is a perspective view of a flexible display apparatus according to another embodiment of the present invention;

FIG. 5B is a perspective view showing a bending state of the flexible display apparatus of FIG. 5A;

FIG. 6A is a perspective view of a flexible display apparatus according to another embodiment of the present invention;

FIG. 6B is a perspective view showing a bending state of the flexible display apparatus of FIG. 6A; and

FIGS. 7A through 7C are diagrams illustrating operating principles of a bendable driving film according to an embodiment of the present invention.

### DETAILED DESCRIPTION

Hereinafter, embodiments of the present invention will be described with reference to accompanying drawings.

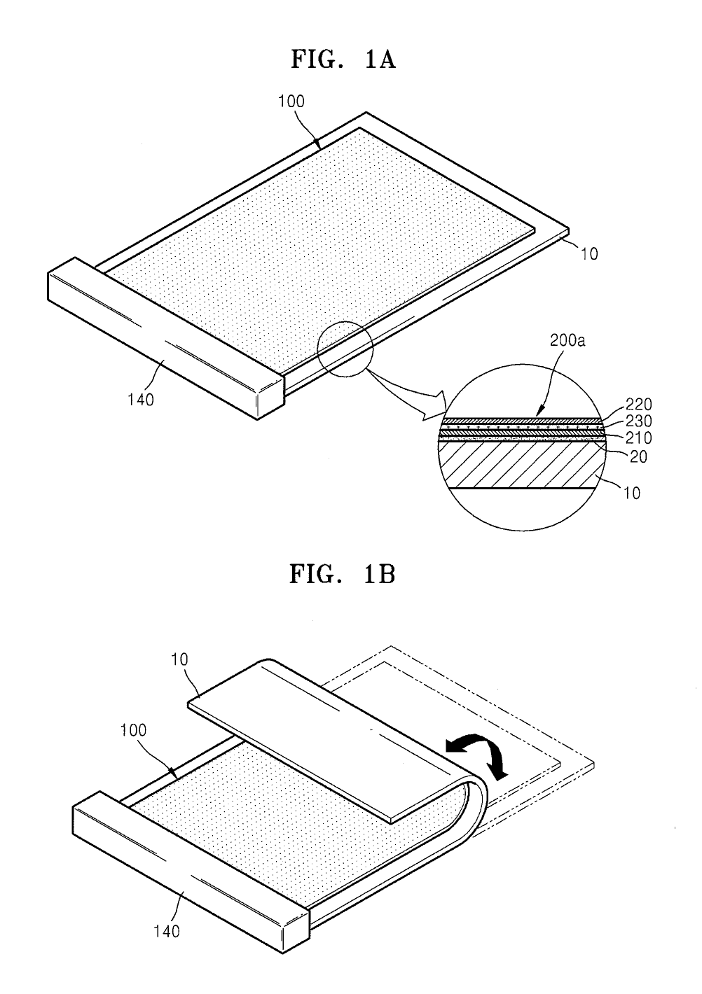

FIGS. 1A and 1B show a flexible display apparatus according to an embodiment of the present invention.

As shown in FIGS. 1A and 1B, a flexible display apparatus of the present embodiment includes a display main body 10 that is flexible, and a bendable driving film 100 attached on a surface of the display main body 10.

The display main body 10, as simply referred, is originally a structure in which a thin film transistor and a light-emitting device for producing images, and an encapsulation layer covering the thin film transistor and the light-emitting device are stacked on a flexible substrate. Since the display main body 10 uses a flexible substrate instead of using a hard glass substrate, the display main body 10 freely curves within a tolerable range of its flexibility.

In addition, the bendable driving film 100 is attached to the surface of the display main body 10 via an adhesive. The bendable driving film 100 has a structure in which an electroactive medium 130 is disposed between a first electrode 110 and a second electrode 120 facing each other, as shown in FIG. 1A. The bendable driving film 100 is driven when components of the electroactive medium 130 concentrate on a side and a bending force is applied according to a direction of electric current flowing in the first and second electrodes 110 and 120.

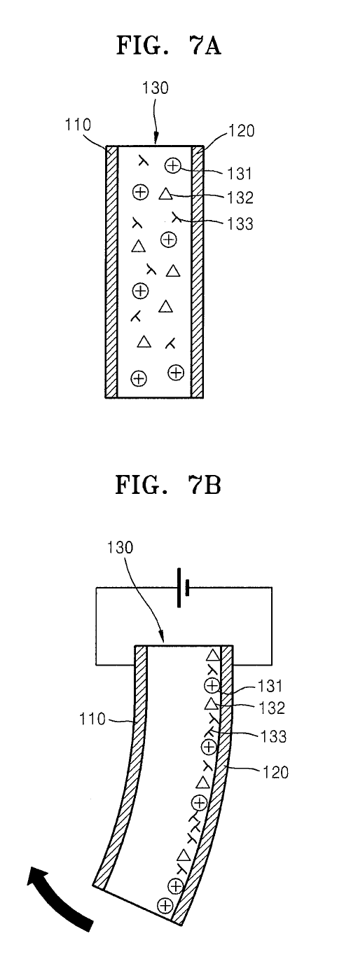

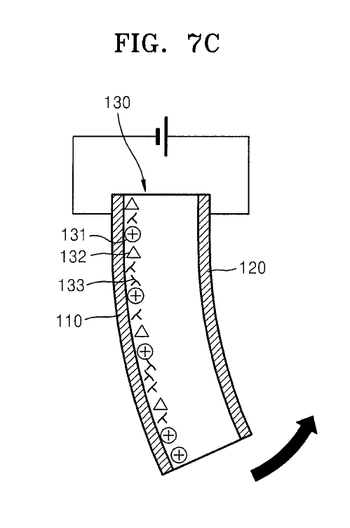

FIGS. 7A through 7C show schematically driving principles of the bendable driving film 100. As shown in FIG. 7A, when electric current does not flow, the electroactive medium is evenly distributed between the first and second electrodes 110 and 120. Here, the electroactive medium 130 includes cations 131, polar solvent 132, and ion exchange polymer 133, as shown in FIG. 7A, and when electric current flows, the cations 131 move toward the electrode of negative polarity while dragging the polar solvent 132. That is, as shown in FIG. 7B, in a state where the positive polarity is applied to the first electrode 110 and the negative polarity is applied to the second electrode 120, the cations 131 move toward the second electrode 120 with the polar solvent 132. That is, the polar solvent 132 concentrates toward the second electrode 120 and the volume of the second electrode 120 expands, and a side of the first electrode 110 contracts, and thus, a bending operation is induced as shown in FIG. 7B.

On the contrary, when the positive polarity is applied to the second electrode 120 and the negative polarity is applied to the first electrode 110, as shown in FIG. 7C, the cations 131 move toward the first electrode 110 with the polar solvent 132 and the ion exchange polymer 133. Accordingly, the polar solvent 132 concentrates at the side of the first electrode 110, thereby expanding a volume of the first electrode 110. Then, a side of the second electrode 120 contracts, and thus, the bending operation shown in FIG. 7C is induced. Therefore, the bending direction may be determined according to an electric conducting direction of the current, and a bending degree may be controlled by adjusting the electric current amount. According to the above-described principle, the bendable driving film 100 is driven, and the display main body 10 on which the bendable driving film 100 is attached is also bent.

Alternatively, an ionic electroactive polymer, a dielectric actuator, a relaxor ferroelectric polymer, or liquid crystal rubber may be used as the electroactive medium 130, and an ionic polymer metal composite, carbon nano-tube, and a conductive polymer may be used as the ionic electroactive polymer. Any one of the above elements, which may induce the bending operation by concentrating at one of the two electrodes during the electric conducting operation, may be used. A bendable driving film in the following embodiments may be formed as described above. Therefore, descriptions of the bendable driving film in the following embodiments are not provided.

Referring back to FIG. 1B, the display main body 10 to which the bendable driving film 100 is attached is bent with the bendable driving film 100 according to the above-described principle when the electric current is supplied from a driving module 140 to the bendable driving film 100. That is, the driving module 140, which is electrically connected to the bendable driving film 100, is installed on a side of the display main body 10, and when the driving module 140 supplies electric current to the bendable driving film 100, one of the first and second electrodes 110 and 120 has the positive polarity and the other has the negative polarity, thereby generating the bending operation. Therefore, when the flexible display apparatus is not in use, the electric current is supplied so that the display main body 10 is bent as shown in FIG. 1B. Then, the display main body 10 having a reduced volume due to the bending may be kept in an appropriate storage form.

On the contrary, when the flexible display apparatus is in use, the display main body 10 is pulled out of storage so that the driving module 140 may apply the electric current to the bendable driving film 100 to be opposite to the example shown in FIG. 1B. Then, the bendable driving film 100 is unfolded to an original state with the display main body 10, and then, the display main body 10 is used in this state to allow the user to watch the flat screen.

Therefore, the direction and the degree of bending may be controlled according to the driving of the bendable driving film 100, and thus, a manipulation of bending the display main body 10 when the display apparatus is carried (not in use for displaying an image) and a manipulation of unfolding the display main body 10 when the display apparatus is in use (for displaying an image) may be performed easily and exactly. Therefore, the convenience of portability and usage may be improved.

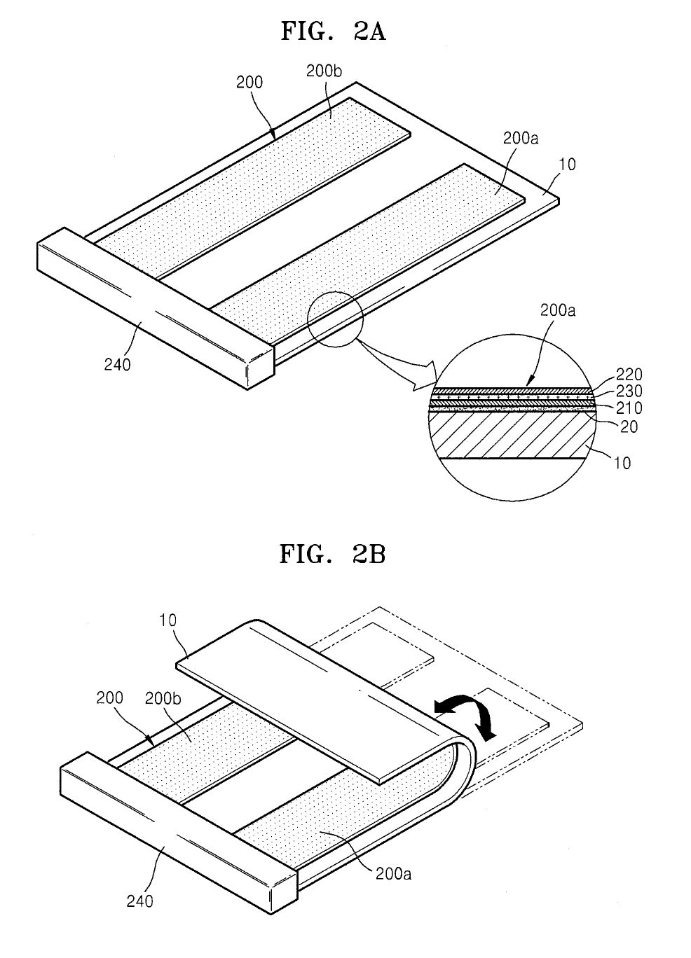

Next, FIGS. 2A and 2B show a flexible display apparatus according to another embodiment of the present invention.

The flexible display apparatus of the present embodiment includes the display main body 10 that is flexible, and a bendable driving film 200 attached to a surface of the display main body 10. The bendable driving film 200 is attached to the surface of the display main body 10 via the adhesive 20, and as shown in FIG. 2A, an electroactive medium 230 is disposed between a first electrode 210 and a second electrode 220 facing each other. In the bendable driving film 200, components of the electroactive medium 230 concentrates on a side according to a direction of the electric current flowing in the first and second electrodes 210 and 220 to bend the bendable driving film 200. On the other hand, in the previous embodiment, the bendable driving film 100 (refer to FIG. 1A) is attached to the surface of the display main body 10 as a single body; however, in the present embodiment, the bendable driving film 200 is divided as a first bendable driving film 200a and a second bendable driving film 200b that are attached to the surface of the display main body 10. That is, the divided first and second bendable driving films 200a and 200b are arranged in parallel with each other to induce the bending and unfolding operations of the display main body 10.

Referring to FIG. 2B, the display main body 10 is bent with the first and second bendable driving films 200a and 200b when the electric current is supplied to the first and second bendable driving films 200a and 200b from a driving module 240. That is, when the driving module 240 that is installed at a side of the display main body 10 supplies the electric current toward the first and second bendable driving films 200a and 200b, one of the first and second electrodes 210 and 220 has the positive polarity and the other has the negative polarity, thereby inducing the bending operation. Therefore, when the display apparatus is not in use, the electric current is supplied so that the display main body 10 may be bent. Then, the display main body 10 having a reduced size due to the bending may be kept in an appropriate storage form.

On the contrary, when the flexible display apparatus is in use, the display main body 10 is pulled out of storage so that the driving module 140 may apply the electric current to the first and second bendable driving films 200a and 200b in a direction opposite to the example shown in FIG. 2B. Then, the first and second bendable driving films 200a and 200b are unfolded to original states with the display main body 10, and in this state, the display main body 10 is driven to allow a user to watch a flat screen.

Therefore, the direction and the degree of bending may be controlled according to the driving of the first and second bendable driving films 200a and 200b, and thus, a manipulation of bending the display main body 10 when the display apparatus is carried and a manipulation of unfolding the display main body 10 when the display apparatus is in use may be performed easily and exactly. Therefore, the convenience of portability and usage may be improved.

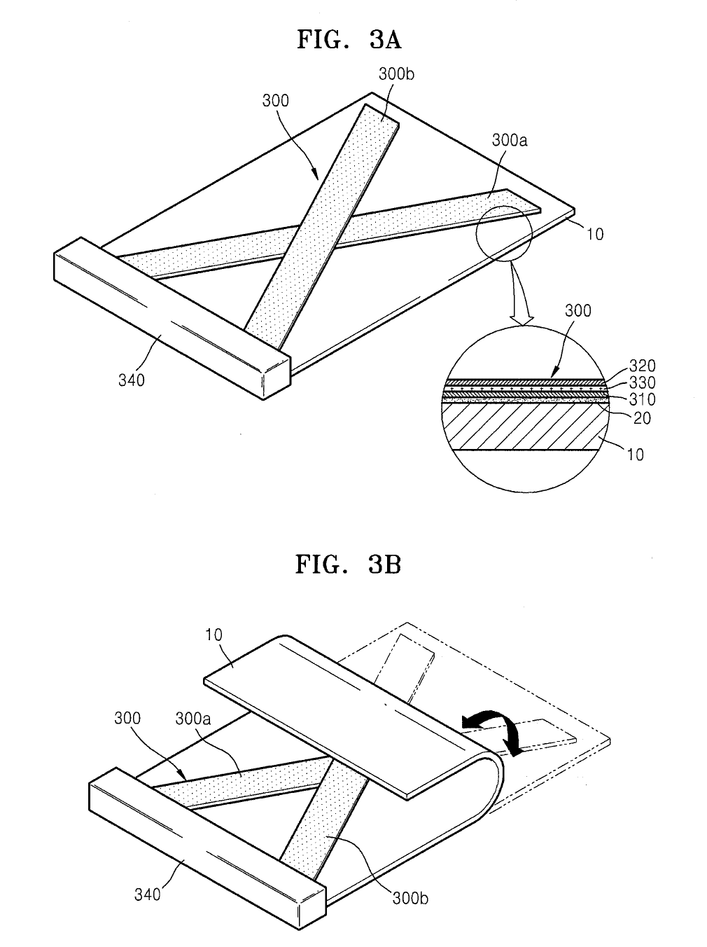

FIGS. 3A and 3B show a flexible display apparatus according to another embodiment of the present invention.

As shown in FIGS. 3A and 3B, the flexible display apparatus of the present embodiment includes the display main body 10 that is flexible, and a bendable driving film 300 attached to a surface of the display main body 10. The bendable driving film 300 is attached to the surface of the display main body 10 via the adhesive 20, and as shown in FIG. 3A, the bendable driving film 300 has a structure in which an electroactive medium 330 is disposed between a first electrode 310 and a second electrode 320 facing each other. In the bendable driving film 300, components of the electroactive medium 330 concentrate on a side according to a direction of the electric current flowing in the first and second electrodes 310 and 320 to bend the bendable driving film 300. Here, the bendable driving film 300 of the present embodiment includes a structure in which a first bendable driving film 300a and a second bendable driving film 300b that are divided are arranged on the surface of the display main body 10 to cross each other.

Referring to FIG. 3B, the display main body 10 is bent with the first and second bendable driving films 300a and 300b when the electric current is supplied to the first and second bendable driving films 300a and 300b from a driving module 340. That is, when the driving module 340 installed at a side of the display main body 10 supplies the electric current to the first and second bendable driving films 300a and 300b, one of the first and second electrodes 310 and 320 has a positive polarity and the other has a negative polarity, thereby inducing the bending operation. Therefore, when the flexible display apparatus is not in use, the electric current is supplied so that the display main body 10 may be bent. Then, the display main body 10 having a reduced size due to the bending may be kept in an appropriate storage.

On the contrary, when the flexible display apparatus is in use, the display main body 10 is pulled out of storage so that the driving module 340 may apply the electric current to the first and second bendable driving films 300a and 300b in a direction opposite to the example shown in FIG. 3B. Then, the first and second bendable driving films 300a and 300b are unfolded to original states with the display main body 10, and in this state, the display main body 10 is driven to allow a user to watch a flat screen.

Therefore, the direction and the degree of bending may be controlled according to the driving of the first and second bendable driving films 300a and 300b, and thus, a manipulation of bending the display main body 10 when the display apparatus is carried and a manipulation of unfolding the display main body 10 when the display apparatus is in use may be performed easily and exactly. Therefore, the convenience of portability and usage may be improved.

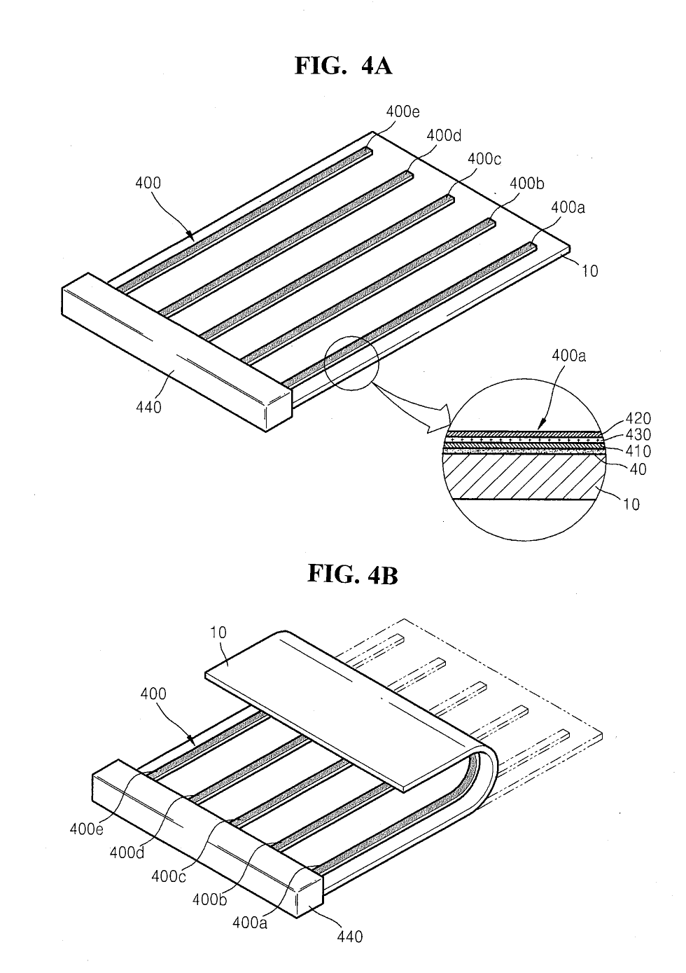

FIGS. 4A and 4B show a flexible display apparatus according to another embodiment of the present invention.

As shown in FIGS. 4A and 4B, the flexible display apparatus of the present embodiment includes the display main body 10 that is flexible, and a bendable driving film 400 attached to a surface of the display main body 10. The bendable driving film 400 is attached to the surface of the display main body 10 via the adhesive 40, and as shown in FIG. 4A, the bendable driving film 400 has a structure in which an electroactive medium 430 is disposed between a first electrode 410 and a second electrode 420 facing each other. In the bendable driving film 400, components of the electroactive medium 430 concentrate on a side according to a direction of the electric current flowing in the first and second electrodes 410 and 420 to bend the bendable driving film 400. On the other hand, the bendable driving film 400 of the present embodiment includes a structure in which a plurality of bendable driving films 400a, 400b, 400c, 400d, and 400e (that are divided) are arranged on the surface of the display main body 10 in parallel with each other.

Referring to FIG. 4B, the display main body 10 is bent with the plurality of bendable driving films 400a, 400b, 400c, 400d, and 400e when the electric current is supplied to the plurality of bendable driving films 400a, 400b, 400c, 400d, and 400e from a driving module 440. That is, when the driving module 440 installed at a side of the display main body 10 supplies the electric current to the plurality of bendable driving films 400a, 400b, 400c, 400d, and 400e, one of the first and second electrodes 410 and 420 has a positive polarity and the other has a negative polarity, thereby inducing the bending operation. Therefore, when the display apparatus is not in use, the electric current is supplied so that the display main body 10 may be bent. Then, the display main body 10 having a reduced size due to the bending may be kept in an appropriate storage form.

On the contrary, when the flexible display apparatus is in use, the display main body 10 is pulled out of storage so that the driving module 440 may apply the electric current to the plurality of bendable driving films 400a, 400b, 400c, 400d, and 400e in a direction opposite to the example shown in FIG. 4B. Then, the plurality of bendable driving films 400a, 400b, 400c, 400d, and 400e are unfolded to original states with the display main body 10, and in this state, the display main body 10 is driven to allow a user to watch a flat screen.

Therefore, the direction and the degree of bending may be controlled according to the driving of the plurality of bendable driving films 400a, 400b, 400c, 400d, and 400e, and thus, a manipulation of bending the display main body 10 when the display apparatus is carried and a manipulation of unfolding the display main body 10 when the display apparatus is in use may be performed easily and exactly. Therefore, the convenience of portability and usage may be improved.

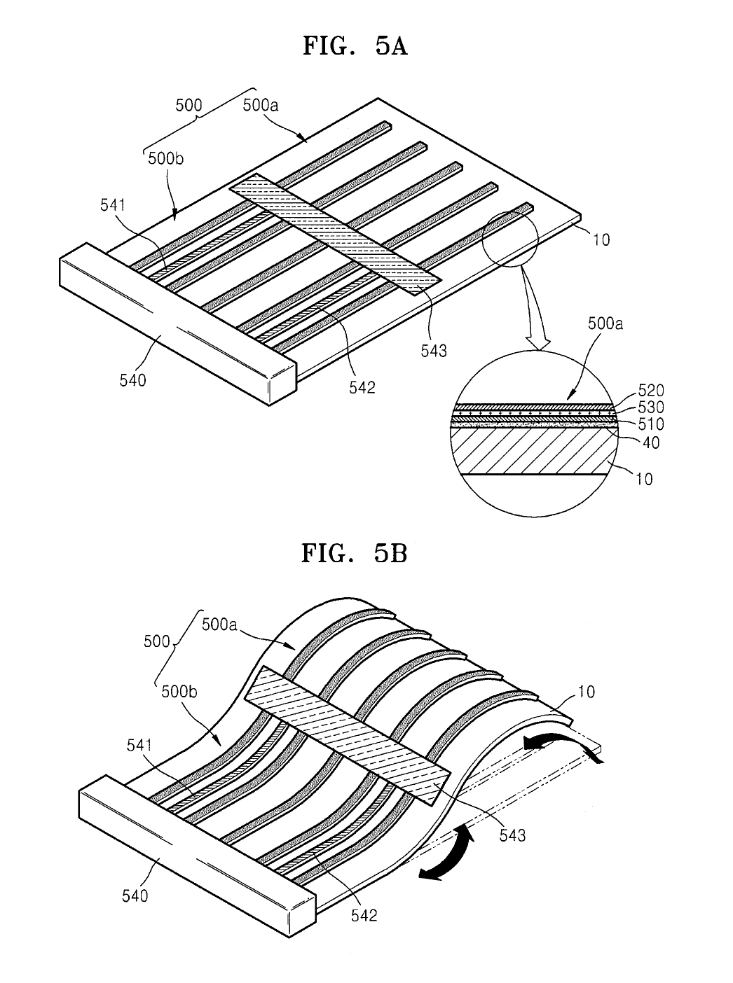

FIGS. 5A and 5B show a flexible display apparatus according to another embodiment of the present invention.

As shown in FIGS. 5A and 5B, the flexible display apparatus of the present embodiment includes the display main body 10 that is flexible, and a bendable driving film 500 attached to a surface of the display main body 10. The bendable driving film 500 is attached to the surface of the display main body 10 via the adhesive 40, and as shown in FIG. 5A, the bendable driving film 500 has a structure in which an electroactive medium 530 is disposed between a first electrode 510 and a second electrode 520 facing each other. In the bendable driving film 500, components of the electroactive medium 530 concentrate on a side according to a direction of the electric current flowing in the first and second electrodes 510 and 520 to bend the bendable driving film 500. On the other hand, the bendable driving film 500 of the present embodiment includes a structure in which a plurality of divided bendable driving films are arranged as an upper film portion 500a and a lower film portion 500b on the surface of the display main body 10. In addition, the upper and lower film portions 500a and 500b are respectively connected to a platform 543 connected to a driving module 540 via connecting wires 541 and 542, and may receive electric currents independently from each other through the platform 543. That is, bending directions and bending degrees of the upper and lower film portions 500a and 500b may be differently controlled from each other.

Referring to FIG. 5B, the display main body 10 is bent with the upper and lower film portions 500a and 500b when the electric current is respectively supplied to the upper and lower film portions 500a and 500b through the platform 543 from the driving module 540. Therefore, when the flexible display apparatus is not in use, the electric current is supplied so that the display main body 10 may be bent as shown in FIG. 5B. Then, the display main body 10 having a reduced size due to the bending may be kept in an appropriate storage form.

On the contrary, when the flexible display apparatus is in use, the display main body 10 is pulled out of storage so that the driving module 540 may apply the electric current to the upper and lower film portions 500a and 500b in a direction opposite to the example shown in FIG. 5B. Then, the upper and lower film portions 500a and 500b are unfolded to original states with the display main body 10, and in this state, the display main body 10 is driven to allow a user to watch a flat screen.

Therefore, the direction and the degree of bending may be controlled according to the upper and lower film portions 500a and 500b, and thus, a manipulation of bending the display main body 10 when the display apparatus is carried and a manipulation of unfolding the display main body 10 when the display apparatus is in use may be performed easily and exactly. Therefore, the convenience of portability and usage may be improved.

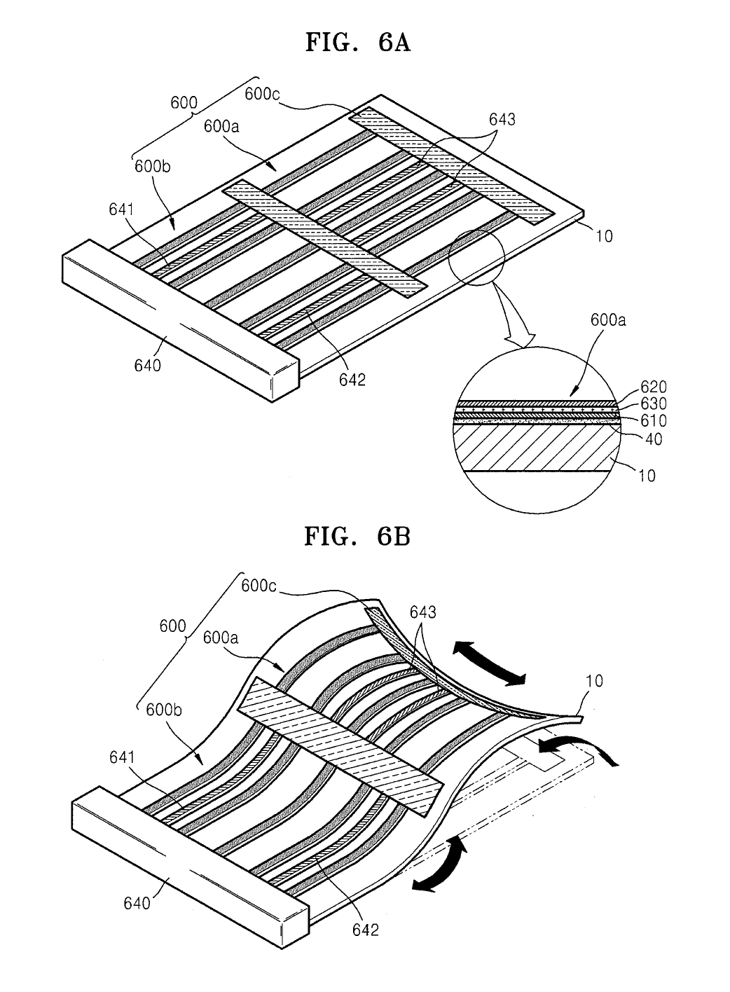

FIGS. 6A and 6B show a flexible display apparatus according to another embodiment of the present invention.

As shown in FIGS. 6A and 6B, the flexible display apparatus of the present embodiment includes the display main body 10 that is flexible, and a bendable driving film 600 attached to a surface of the display main body 10. The bendable driving film 600 is attached to the surface of the display main body 10 via the adhesive 40, and as shown in FIG. 6A, the bendable driving film 600 has a structure in which an electroactive medium 630 is disposed between a first electrode 610 and a second electrode 620 facing each other. In the bendable driving film 600, components of the electroactive medium 630 concentrate on a side according to a direction of the electric current flowing in the first and second electrodes 610 and 620 to bend the bendable driving film 600. On the other hand, the bendable driving film 600 of the present embodiment includes a structure in which a plurality of divided bendable driving films are arranged as an upper film portion 600a, a lower film portion 600b, and a vertical film portion 600c on the surface of the display main body 10. In addition, the upper film portion 600a, the lower film portion 600b, and the vertical film portion 600c are connected to a driving module 640 respectively through connecting wires 641, 642, and 643, and may receive electric currents independently from each other. That is, bending directions and bending degrees of the upper film portion 600a, the lower film portion 600b, and the vertical film portion 600c may be differently controlled from each other. Here, the vertical film portion 600c is disposed perpendicular to the upper and lower film portions 600a and 600b, and a bending direction of the vertical film portion 600c is also perpendicular to those of the upper and lower film portions 600a and 600b.

Referring to FIG. 6B, the display main body 10 is bent with the upper film portion 600a, the lower film portion 600b, and the vertical film portion 600c when the electric current is respectively supplied to the upper film portion 600a, the lower film portion 600b, and the vertical film portion 600c from the driving module 640. Therefore, when the flexible display apparatus is not in use, the electric current is supplied so that the display main body 10 may be bent as shown in FIG. 6B. Then, the display main body 10 having a reduced size due to the bending may be kept in an appropriate storage form.

On the contrary, when the flexible display apparatus is in use, the display main body 10 is pulled out of storage so that the driving module 640 may apply the electric current to the upper film portion 600a, the lower film portion 600b, and the vertical film portion 600c in a direction opposite to the example shown in FIG. 6B. Then, the upper film portion 600a, the lower film portion 600b, and the vertical film portion 600c are unfolded to original states with the display main body 10, and in this state, the display main body 10 is driven to allow a user to watch a flat screen.

Therefore, the direction and the degree of bending may be controlled according to the upper film portion 600a, the lower film portion 600b, and the vertical film portion 600c, and thus, a manipulation of bending the display main body 10 when the display apparatus is carried and a manipulation of unfolding the display main body 10 when the display apparatus is in use may be performed easily and exactly. Therefore, the convenience of portability and usage may be improved.

According to a flexible display apparatus that has the above-described structure, a main body of the flexible display apparatus may be flexibly transformed when it is carried, and may be unfolded to be flat through a simple manipulation when the flexible display apparatus is in use, and accordingly, the convenience of portability and usage may be improved.

While the present invention has been particularly shown and described with reference to exemplary embodiments thereof, it will be understood by those of ordinary skill in the art that various changes in form and details may be made therein without departing from the spirit and scope of the present invention as defined by the following claims, and equivalents thereof.

What is claimed is:

1. A flexible display apparatus comprising:
a display main body that is flexible; and
a bendable driving film coupled to the display main body, and configured to bend when an electric current flows.

2. The flexible display apparatus of claim 1, wherein the bendable driving film comprises a first electrode and a second electrode facing each other, and an electroactive medium disposed between the first and second electrodes, wherein components of the electroactive medium concentrate to one of the first and second electrodes to induce a bending operation according to a direction of the electric current flowing in the first and second electrodes.

3. The flexible display apparatus of claim 2, wherein the electroactive medium comprises one selected from the group consisting of ionic electroactive polymers, dielectric actuators, relaxor ferroelectric polymers, liquid crystal rubbers, and combinations thereof.

4. The flexible display apparatus of claim 3, wherein the ionic electroactive polymer comprises one selected from the group consisting of ionic polymer metal composites, carbon nano tubes, conductive polymers, and combinations thereof.

5. The flexible display apparatus of claim 1, wherein the bendable driving film is attached to a surface of the display main body as a single body.

6. The flexible display apparatus of claim 1, wherein the bendable driving film is attached to a surface of the display main body as a plurality of divided pieces.

7. The flexible display apparatus of claim 6, wherein the bendable driving film comprises a first bendable driving film and a second bendable driving film that are attached to the surface of the display main body along a first direction in parallel with each other.

8. The flexible display apparatus of claim 6, wherein the bendable driving film comprises a first bendable driving film and a second bendable driving film that are attached to the surface of the display main body to cross each other.

9. The flexible display apparatus of claim 6, wherein a plurality of the bendable driving films are attached to the surface of the display main body along a first direction in parallel with each other.

10. The flexible display apparatus of claim 6, wherein the bendable driving film comprises upper film portions attached to an upper portion of the surface of the display main body along a first direction in parallel with each other, and lower film portions attached to a lower portion of the surface of the display main body in parallel with each other, and the upper and lower film portions are configured to respectively flow electric currents therein independent from each other.

11. The flexible display apparatus of claim 6, wherein the bendable driving film comprises upper film portions attached to an upper portion of the surface of the display main body along a first direction in parallel with each other, lower film portions attached to a lower portion of the surface of the display main body in parallel with each other, and vertical film portions attached along a second direction that is perpendicular to the first direction, and the upper film portion, the lower film portions, and the vertical film portions are configured to respectively flow electric currents therein independent from each other.
